(19) United States
(12) Patent Application Publication
(10) Pub. No.: US 2021/0132888 A1
(43) Pub. Date: May 6, 2021

(54) PEER-TO-PEER AS-A-SERVICE FOR PRINTER SHARING

(71) Applicant: KYOCERA Document Solutions, Inc., Osaka (JP)

(72) Inventors: Satoshi K. Yuki, San Pedro, CA (US); Sam Chinh Co Tang Chan, Garden Grove, CA (US)

(21) Appl. No.: 16/670,348

(22) Filed: Oct. 31, 2019

(51) Int. Cl. G06F 3/12; H04L 29/08; G06Q 20/36

(52) U.S. Cl. CPC G06F 3/1272; H04L 67/02; G06Q 2220/00; G06Q 20/3678; G06F 3/1204

(57) ABSTRACT

Printer sharing is disclosed. In a method thereof, printers, including corresponding network addresses, are identified for peer-to-peer print services. Prices are obtained for the peer-to-peer print services associated with the printers. A website- or app-accessible platform (“platform”) is provided for coordinating availability and pricing for the peer-to-peer print services of the printers. A user interface is provided to select a printer of the printers at a price of the prices. A print job is forwarded from the platform to the selected printer of the printers. The print job is printed by the selected printer A payment associated with the price is credited to an account associated with the selected printer.

### FIELD

The following description relates to sharing a printer. More particularly, the following description relates to peer-to-peer as-a-service for printer sharing.

### BACKGROUND

Conventionally, printers remain idle when not in use by their owner, whether such owner is an individual or a business.

### SUMMARY

In accordance with one or more below described examples, a method relating generally to printer sharing is disclosed. In such a method, printers, including corresponding network addresses, are identified for peer-to-peer print services. Prices are obtained for the peer-to-peer print services associated with the printers. A website- or app-accessible platform (“platform”) is provided for coordinating availability and pricing for the peer-to-peer print services of the printers. A user interface is provided to select a printer of the printers at a price of the prices. A print job is forwarded from the platform to the selected printer of the printers. The print job is printed by the selected printer. A payment associated with the price is credited to an account associated with the selected printer.

In accordance with one or more below described examples, a system relating generally to printer sharing is disclosed. In such a system, networked computers are programmed to provide a website- or app-accessible platform (“platform”) to coordinate availability and pricing for peer-to-peer print services of printers of one or more sellers. The printers having corresponding network addresses for the peer-to-peer print services and associated prices for the peer-to-peer print services. The platform is programmed to provide a user interface for a buyer to select a printer of the printers at a price of the prices. The platform is programmed to forward to the selected printer of the printers a print job of the buyer responsive to payment for execution of the print job. The platform is programmed to indicate crediting the payment associated with the price to an account associated with the selected printer responsive to confirmation of the execution of the print job.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a block-flow diagram depicting an example of a printer-share system flow.

FIG. 2 is a block diagram depicting an example of a printer-share use flow, such as for the printer-share system flow of FIG. 1.

FIG. 3 is a block diagram depicting an exemplary printer sharing system.

FIG. 4 is block diagram depicting an example of a portable communication device.

FIG. 5 is a pictorial diagram depicting an example of a network.

FIG. 6 is a block diagram depicting an example of a printing device.

FIG. 7 is a block diagram depicting an example of a computer/printing device system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are, used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

Printers may be idle as individuals and businesses become more paperless. However, printers continue to be used by individuals and businesses. As described below in additional detail, printer sharing in a peer-to-peer as-a-service environment may be used to capitalize on such idleness of printers.

With the above general understanding borne in mind, various configurations for printer sharing systems and methods are generally described below.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples,

For purposes of explanation, specific nomenclature is set forth to provide a thorough understanding of the various concepts disclosed herein. However, the terminology, used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc. may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or sewer. In the latter scenario, the remote computer may be connected to the user's computer through a local area network (“LAN”) or a wide area network (“WAN”), or the connection may be made to an external computer (for example, through the Internet using an Internet Service Provider),

Systems and methods described herein may relate to an apparatus for performing the operations associated therewith. This apparatus may be specially constructed for the purposes identified, or it may, include a general-purpose computer selectively activated or reconfigured by a computer program stored in the computer

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples, In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also two or more operations may be performed concurrently or with partial concurrence. Such variation will depend on the software and hardware systems chosen and on designer choice. It is understood that all such variations are within the scope of the disclosure, Likewise, software and web implementations may be accomplished with standard programming techniques with rule based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs,

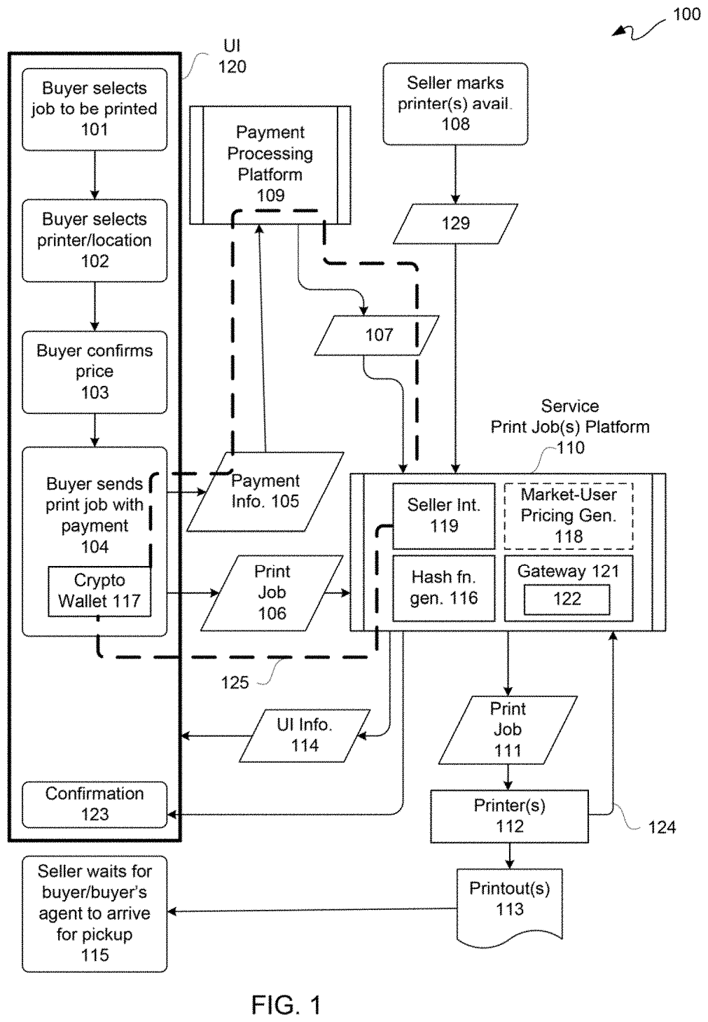

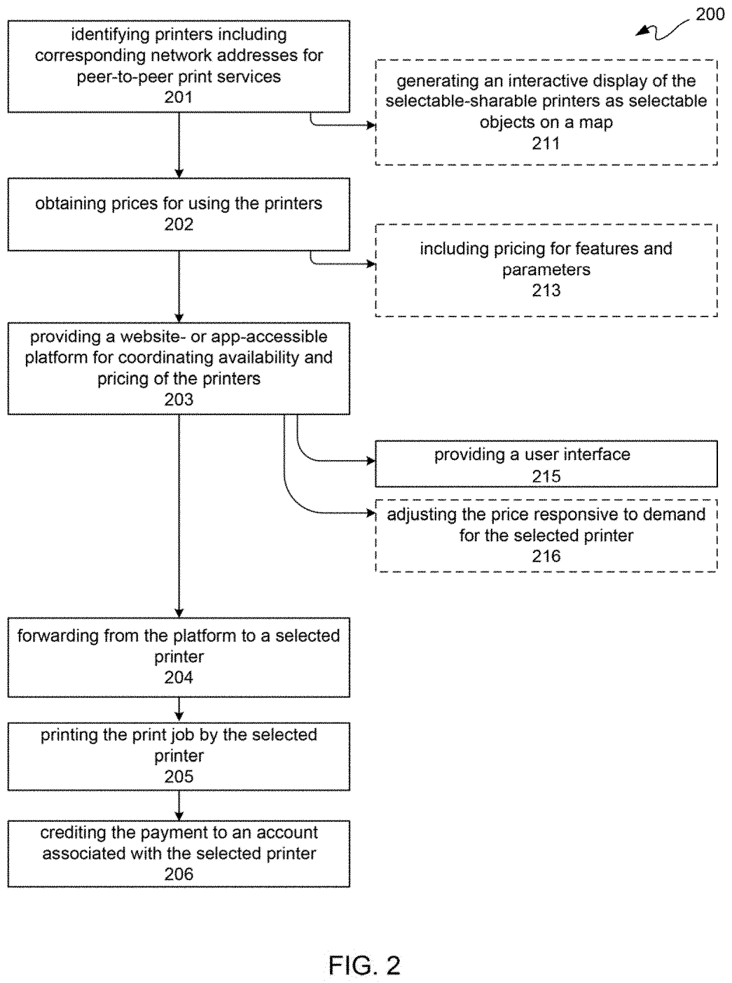

FIG. 1 is a block-flow diagram depicting an example of a printer-share system flow 100. FIG. 2 is a block diagram depicting an example of a printer-share use flow 200, such as for printer-share system flow 100 of FIG. 1. Flows 100 and 200 are further described with simultaneous reference to FIGS. 1 and 2.

Printer-share system flow 100 may be a web-based application for sharing a printer in a peer-to-peer environment, whether as software-as-a-service and/or platform-as-a-service (PaaS). Such a web-based application may be for an access or share economy, where an owner or other agent of a printer may make such printer available to others.

Along those lines, at operation 108, an offeror, such as a seller of a print service or other agent of one or more printers, may electronically identify or mark one or more of such printers available for shared access to a seller-side or seller interface 119 of a platform 110. For an operation 108, at operation 201 one or more offerors (“sellers”) may each identify one or more printers, which they have ownership, agency or same or similar control over. Such identification at operation 201 may include identification of corresponding network addresses of such printers for peer-to-peer print services. For purposes of clarity by way of example and not limitation, it shall be assumed that a seller is making “share available” multiple printers.

Along those lines, not all of such printers, whether from a single seller or multiple sellers, may be geographically located at a same location. Optionally, at operation 201 identification of such printers may include identifying physical addresses of such printers, which in turn may optionally be used to generate at operation 211 an interactive display of selectable-sharable printers, such as selectable objects on a map as may be displayed on, a display.

At operation 202, prices for using such printers identified at operation 201 may be provided by a seller or generated within such application or a combination thereof. Optionally, an acceptor, such as a purchaser or buyer, may select options for use of a printer at operation 202, and such selection may include at operation 213 different prices for different features and/or print job parameters. For example, a seller may identify a feature set for a printer, and prices may be adjusted responsive to one or more selectable features. Furthermore, prices may be adjusted responsive to parameters of a print job, such, as number of pages and/or number, size, resolution, and colors of any images. These and/or other print job features and/or parameters may be included,

Network, and other information of printer data 129 regarding such printers identified at operation 108 may be provided to a service print job(s) platform 110. Service print job(s) platform 110 may be provided as a website- or app-accessible platform. Along those lines, service print job(s) platform (“platform”) 110 may be provided at operation 203 for coordinating availability and pricing of available printers identified at operation 201.

Platform 110 may be a cloud-based platform with backend applications in accordance with the description herein. Along those lines, platform 110 may include a seller interface 119 configured for making one or more printers of sellers available for printing by acceptors, namely buyers or purchasers, and communicating network addresses for such one or more printers. Seller interface 119 may be configured responsive availability and network information in printer data 129.

While a platform 110 owner or operator may own printers which are made available for peer-to-peer services as described herein, for purposes of clarity and not limitation, the examples herein assume a platform 110 owner or operator is just providing services associated with connecting sellers and buyers for peer-to-peer printing services in a share or access economy model. In another example, a platform 110 owner or operator may have a printer farm for offer peer-to-peer printing services, though not in a share or access economy model.

Platform 110 may include a gateway network appliance (“gateway”) 121. Gateway 121, which may be in communication with seller interface 119, may be configured to receive and store network addresses of such one or more marked available and in-use printers of printers 112 in a table 122 for example. Along those lines, gateway 121 may be configured with network addresses for selectable-sharable printers and network address translation for having the network addresses of such selectable-sharable printers as private with a public address for gateway 121 for user access, such as via a platform 110 provided buyer-side interface or user interface (UI) 120.

Platform 110 may be configured with an optional market-user price generator app 118. Market-user price generator app 118 may be configured to generate prices for corresponding print jobs 106, such as for print outs thereof. Prices may be different for one or more identified printers 112 depending for example on selected feature set and/or print job parameters. Market-user price generator app 118 may optionally be configured to adjust pricing at operation 216 responsive to demand for a selected printer.

Platform 110 may provide a UI 120 at operation 215. Such UI 120 may be provided via the Internet and/or other network to a purchaser- or buyer-side device, which may be a desktop, notebook, tablet, smart phone, or other web browser capable device. UI 120 may be configured to have a purchaser or buyer (“buyer”) select a file or other item to be printed at operation 101. Such selection may load such selected item (“print job”) 106 for subsequent sending, as described below in additional detail.

At operation 102 of a UI 120, a buyer may select a printer and corresponding location thereof to pick up such print job 106 after printing. Platform 110 may provide UI information 114, including pricing, availability, location, and other information, on printer(s) to UI 120.

A location may have more than one available printer, and so a buyer may select a printer at a location. For a location with only one printer, selection of a location may likewise select a printer. Such selection may be from an optional map generated at operation 211, which map may be viewable with UI 120. For example, UI 120 may be configured to generate an interactive display of one or more printers as selectable objects on a localized map, where location of a buyer may be used. Optionally, a buyer may select a delivery service for delivery of a print out at operation 102. In some instances, there may be an additional charge for use of a delivery service.

Information regarding features of a printer, printing options, and other options affecting pricing, as well as a base price for use of a printer for a printing service, may be provided as part of UI information 114. Such pricing information may be useful to a buyer to select a printer. Optionally, estimated costs for printing, including any options, may be generated by obtaining information regarding a print job 106 directly from a loaded selected item and applying such pricing information to such print job 106.

UI 120 may be configured to adjust prices responsive to user selected features and parameters for a print job. UI 120 may be configured to adjust prices responsive to demand for selected printers. For example, UI 120 may have price fields which are populated with outputs from market-user pricing generator app 118.

Platform 110 may include a hash function generator 116 for generating unique identifiers for printers, Such unique identifiers may be embedded in UI information 114.

At operation 103 of UI 120, a buyer may confirm price for a loaded print job. At operation 104 of UI 120, a buyer may make a payment for such print job and may send such payment information 105 and a print job 106, including printer information for a selected printer. Payment information 105 may include a unique identifier associated with a selected printer for such print job 106. Print job 106 may be sent o platform 110.

In this example, UI 120 may access a crypto wallet 117 of a buyer's device or accessible via a buyer's device for making such payment. Such payment information 105 may be sent to a payment processing platform 109. Payment processing platform 109 may confirm or deny payment, and provide transaction information 107, along with such unique identifier, to platform 110.

In this example, a payment is a crypto currency transaction. In this example, a bitcoin crypto currency is used; however, this or another crypto currency may be used in other examples. In another example, a buyer may pay with a credit card or online payment service provided at least in part via payment processing platform 109.

Digital wallets, such as crypto wallet 117 for example, can be backed up and “copied”. However, a digital wallet may only store a public key and a private key. The public key identifies the wallet and basically works like a debit card number, while the private key allows spending funds, like the PIN of a debit card. All transactions may be recorded in a blockchain 125. Accordingly, payment processing platform 109 may be configured to debit a buyer account and credit a platform account, less any transaction fee. By using blockchain, a correspondence between a payment and a print job may be maintained for positive identification of a user picking up a completed print job. Furthermore, a degree of anonymity may be maintained between a user requesting, a print job and its associated payment information. For example, a debit card number or other identifier need not be tied to a name, so it in effect may be an unnamed debit account. Additionally, in an example, a lost private key may make all funds associated with it impossible to retrieve, as the only way to access such funds is with such private key. A public key can be regenerated from a corresponding private key, but such private key cannot be regenerated.

A service fee may be charged for use of platform 110 to either or both seller and buyer. Such crypto currency transactions may be recorded in blockchain 125.

Platform 110 may receive transaction information 107 and pair such transaction information with a received print job 106 using a corresponding print job identifier. For a paid transaction as indicated by transaction information 107, platform 110 may forward a print job 106 and corresponding transaction information 107 as print job 111 to a selected printer of one or more available printers 112. Transaction information 107 may include printer information for configuring such selected printer for such print job, as well as information to associate such print job with a buyer thereof. Transaction information 107 may include payment information or payments, each which may be a crypto currency transaction. More generally, platform 110 may be operable to forward print jobs 107 and corresponding transaction information 107 as crypto transactions, which are generally indicated as print jobs 111 in the figure, to respective selected printers of printers 112 for execution of print jobs 196.

Using seller interface 119, platform 110 may credit a seller's account, which may be less any service fee, for such paid transaction for a print job to be completed on such seller's printer. Crediting of a seller's account in this example may be recorded in blockchain 125. However, in another example, a separate blockchain between platform 110 and a seller may be used for recording such transactions.

A seller may access seller interface 119 to see how much credit each and all printers such seller has agency over have generated in revenue. Such seller may set such account to automatically credit one or more accounts of seller upon confirmation of completion of each print job.

At operation 204, platform 110 may forward print jobs 111 and corresponding transaction information to respective selected printers of one or more available printers 112 for executing such print jobs 106. At operation 205, a selected printer of printers 112 may print a received print job 111.

Printers 112 may be configured to print out transaction information for a print job along with such print job printout 113. Accordingly, a selected printer of printers 112 may print out a document for a buyer's transaction along with such print job.

Confirmation 124 may be sent by such a selected printer to platform 110 to confirm completion of a print job. In response to confirmation 124, platform 110 may send a confirmation 123 to UI 120 indicating an ordered print job was completed, which confirmation may include details of such printout and delivery information. At operation 206, confirmation 124 may be used as a trigger to credit a payment to an account associated with such selected printer for such print job. At operation 115, a seller or agent of a seller may wait for a buyer or a buyer's agent to arrive for pickup of one or more printouts 113, unless such printouts are to be delivered to buyer or buyer's agent.

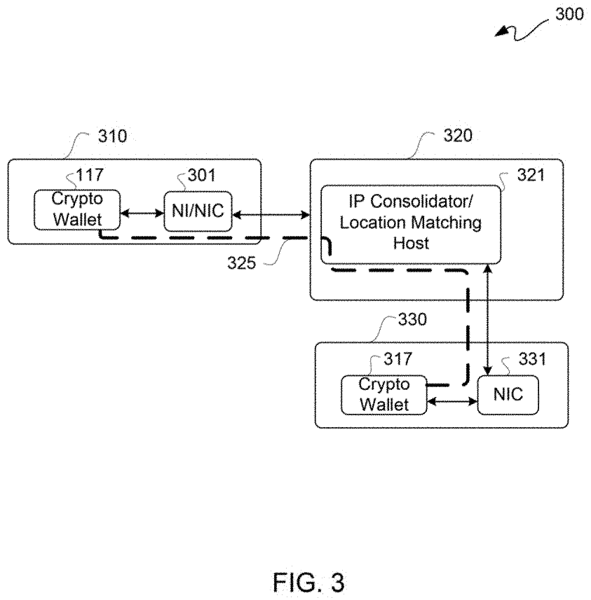

FIG. 3 is a block diagram depicting an exemplary printer sharing system 300. Printer sharing system 300 may be accessible via a web-browser device 310, such as for example a smart phone, a computer, or other web-browser capable device. In this example, such web-browser device 310 includes a crypto wallet 117, which may be put in network communication via a network interface or network interface card (NIC) 301 of web-browser device 310.

Along those lines, web-browser device 310 may be put in networked communication with a SaaS and/or PaaS provider (“SPP”) system 320. Such networked communication in this example is for an Internet Protocol (“IP”); however, in another example, another network protocol may be used.

SPP system 320 may be configured with programmed networked computers to provide an IP consolidator and location matching host 321. SPP system 320 may be configured to provide services, such as SaaS and/or PaaS as described herein.

SPP system 320 may be in networked communication with a printing device 330, such as a printer of selectable printers 112 of FIG. 1. Printing device 330 includes a NIC 331 for such networked communication. In this example, such printing device 330 includes a crypto wallet 317, which may be put in network communication via NIC 331 with IP consolidator and location matching host 321, and from there to crypto wallet 117 of web-browser device 310. In this example, a crypto wallet-to-crypto wallet transaction from a buyer to a seller's printer may be performed with a blockchain 325.

Because one or more of the examples described herein may be implemented in using a network, such as for a cloud-based SaaS and/or PaaS implementation, or a computing/printing device system, as well as a mobile device and a printing device, a detailed description of examples of each is provided. However, it should be understood that other configurations of one or more of these examples may benefit from the technology described herein.

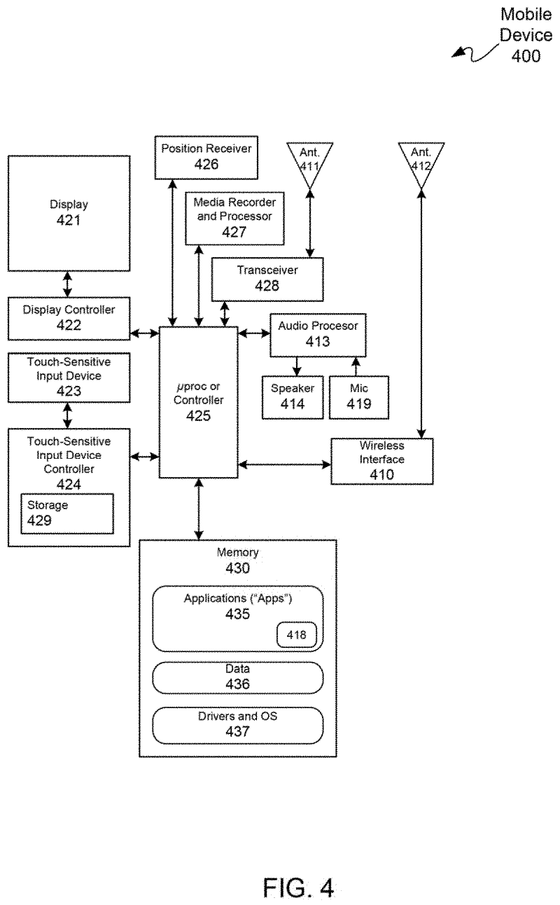

FIG. 4 is block diagram depicting an example of a portable communication device (“mobile device”) 400. Mobile device 400 may be an example of a mobile device, as described elsewhere herein.

Mobile device 400 may include a wireless interface 410, an antenna 411, an antenna 412, an audio processor 413, a speaker 414, and a microphone (“mic”) 419 a display 421, a display controller 422, a touch-sensitive input device 423, a touch-sensitive input device controller 424, a microprocessor or microcontroller 425, a position receiver 426, a media recorder-processor 427, a cell transceiver 428, and a memory or memories (“memory”) 430.

Microprocessor or microcontroller 425 may be programmed to control overall operation of mobile device 400. Microprocessor or microcontroller 425 may include a commercially available or custom microprocessor or microcontroller.

Memory 430 may be interconnected for communication with microprocessor or microcontroller 425 for storing programs and data used by mobile device 400. Memory 430 generally represents an overall hierarchy of memory devices containing software and data used to implement functions of mobile device 400. Data and programs or apps as described hereinabove may be stored in memory 430.

Memory 430 may include, for example, RAM or other volatile solid-state memory, flash or other non-volatile solid-state memory, a magnetic storage medium such as a hard disk drive, a removable storage media, or other suitable storage means. In addition to handling voice communications, mobile device 400 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 430 stores drivers, such as I/O device drivers, and operating system programs (“OS”) 437. Memory 430 stores application programs (“apps”) 435 and data 436. Data may include application program data. An app 418 may be for generating UI 120 for access to an app-accessible platform 110.

I/O device drivers may include software routines accessed through microprocessor or microcontroller 425 or by an OS stored in memory 430. Apps, to communicate with devices such as the touch-sensitive input device 423 and keys and other user interface objects adaptively displayed on a display 421, may use one or more of such drivers.

Mobile device 400, such as a mobile or cell phone, includes a display 421. Display 421 may be operatively coupled to and controlled by a display controller 422, which may be a suitable microcontroller or microprocessor programmed with a driver for operating display 421.

Touch-sensitive input device 423 may be operatively coupled to and controlled by a touch-sensitive input device controller 424, which may be a suitable microcontroller or microprocessor. Along those lines, touching activity input via touch-sensitive input device 423 may be communicated to touch-sensitive input device controller 424. Touch-sensitive input device controller 424 may optionally include local storage 429.

Touch-sensitive input device controller 424 may be programmed with a driver or application program interface (“API”) for apps 435. An app may be associated with a service, as previously described herein, for use of a SaaS for example. One or more aspects of above-described apps may operate in a foreground or background mode.

Microprocessor or microcontroller 425 may be programmed to interface directly with touch-sensitive input device 423 or through touch-sensitive input device controller 424. Microprocessor or microcontroller 425 may be programmed or otherwise configured to interface with one or more other interface device(s) of mobile device 400. Microprocessor or microcontroller 425 may be interconnected for interfacing with a transmitter/receiver (“transceiver”) 428, audio processing circuitry, such as an audio processor 413, and a position receiver 426, such as a global positioning system (“GPS”) receiver. An antenna 411 may be coupled to transceiver 428 for bi-directional communication, such as cellular and/or satellite communication.

Mobile device 400 may include a media recorder-processor 427, such as a still camera, a video camera, an audio recorder, or the like, to capture digital pictures, audio and/or video. Microprocessor or microcontroller 425 may be interconnected for interfacing with media recorder-processor 427 Image, audio and/or video files corresponding to the pictures, songs and/or video may be stored in memory 430 as data 436.

Mobile device 400 may include an audio processor 413 for processing audio signals, such as for example audio information transmitted by and received from transceiver 428. Microprocessor or microcontroller 425 may be interconnected for interfacing with audio processor 413. Coupled to audio processor 413 may be one or more speakers 414 and one or more microphones 419, for projecting and receiving sound, including without limitation recording sound, via mobile device 400. Audio data may be passed to audio processor 413 for playback. Audio data may include, for example, audio data from an audio file stored in memory 430 as data 436 and retrieved by microprocessor or microcontroller 425. Audio processor 413 may incl de buffers, decoders, amplifiers and the like.

Mobile device 400 may include one or more local wireless interfaces 410, such as a WiFi interface, an infrared transceiver, and/or an RF adapter. Wireless interface 410 may provide a Bluetooth adapter, a WLAN adapter, an Ultra-Wideband (“UWB”) adapter, and/or the like. Wireless interface 410 may be interconnected to an antenna 412 for communication. As is known, a wireless interface 410 may be used with an accessory, such as for example a hands-free adapter and/or a headset. For example, audible output sound corresponding to audio data may be transferred from mobile device 400 to an adapter, another mobile radio terminal, a computer, or another electronic device. In another example, wireless interface 410 may be for communication within a cellular network or another Fireless Wide-Area Network (WWAN).

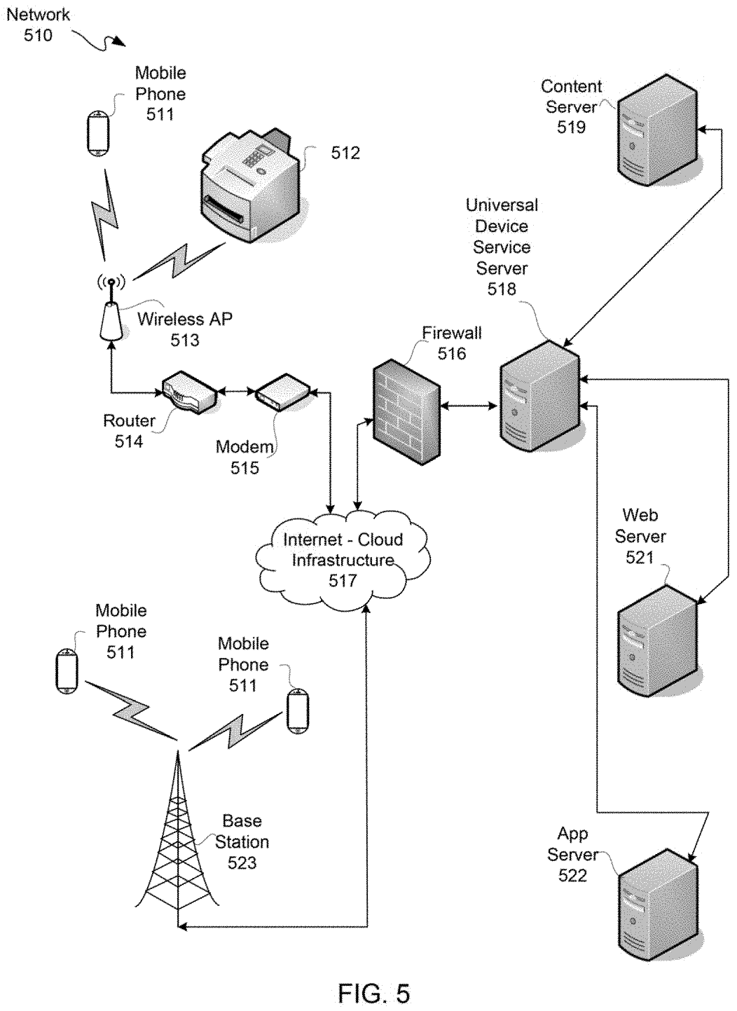

FIG. 5 is a pictorial diagram depicting, an example of a network 510, which may be used to with an SaaS and/or PaaS platform for hosting a service or micro service for use by a user device, as described herein. Along those lines, network 510 may include one or more mobile phones, pads, desktops, notebooks, and/or other web-usable devices 511 in wired and/or wireless communication with a wired and/or wireless access point (“AP”) 513 connected to or of a wireless router 514. Furthermore, one or more of such web-usable wireless devices 511 may be in wireless communication with a base station 523. Additionally, a printing device 512 may be web-usable and may be in wireless and/or wired communication to and from router 514.

Wireless AP 513 may be connected for communication with a router 514, which in turn may be connected to a modem 515. Modem 515 and base station 523 may be in communication with an Internet-Cloud infrastructure 517, which may include public and/or private networks.

A firewall 516 may be in communication with such an Internet-Cloud infrastructure 517. Firewall 516 may be in communication with a universal device service server 518. Universal device service server 518 may be in communication with a content server 519, a web server 524, and/or an app server 522. App server 522, as well as a network 510, may be used for downloading an app or one or more, components thereof for accessing and using a service or a micro service as described herein.

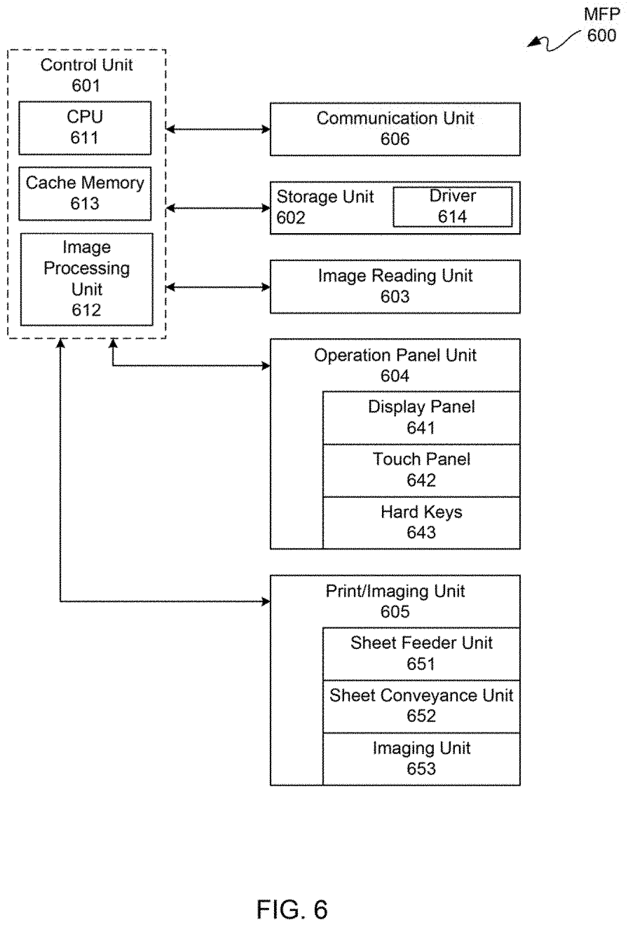

FIG. 6 is a block diagram depicting an example of a printing device 600. In this example, a printing device 600 is a multi-function printer (MFP) 600. However, in another example, another type of printing device 600 may be used, such as for example a standalone printer. MFP 600 is provided for purposes of clarity by way of non-limiting example.

MFP 600 in this example includes a control unit 601, a storage unit 602 an, image reading unit 603, an operation panel unit 604, a print/imaging unit 605, and a communication unit 606. Communication unit 606 may be coupled to a network for communication with other peripherals, mobile devices, computers, servers, and/or other electronic devices. In another example, control unit 601 may be separate from MFP 600.

Control unit 601 may include a CPU 611, an image processing unit 612, and cache memory 613. Storage unit 602 may include ROM, RAM, and large capacity storage memory, such as for example an HDD or an SSD. Storage unit 602 may store various types of data and control programs, including without limitation a printer driver 614.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

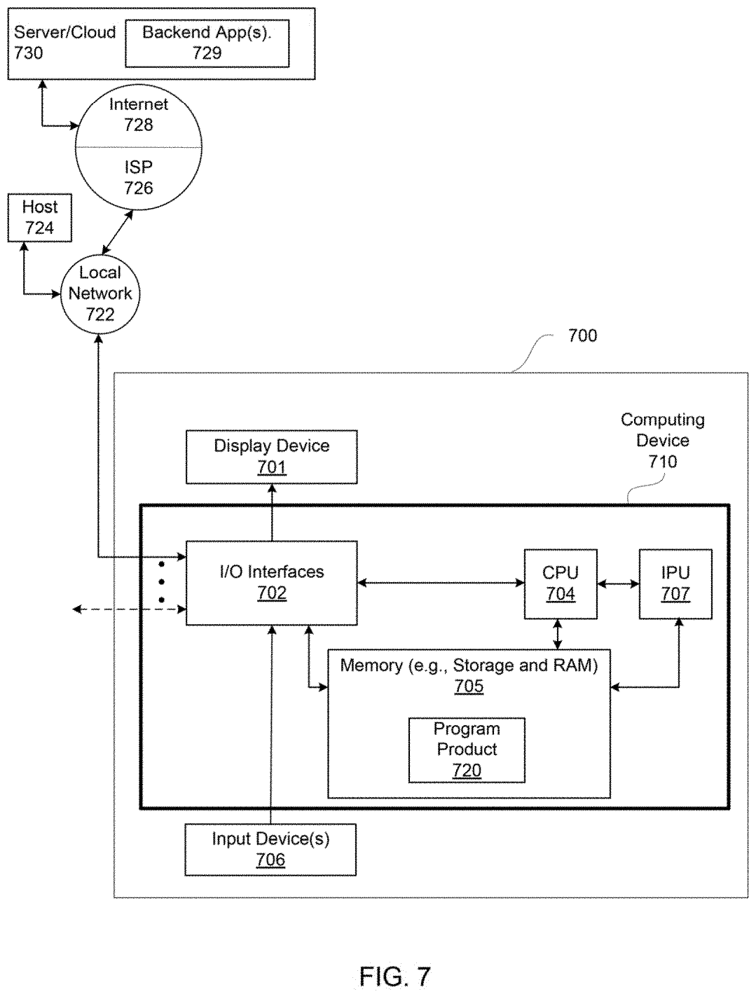

FIG. 7 is a block diagram depicting an example of a computing/printing device system (“system”) 700 upon which one or more aspects described herein may be implemented. System 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. System 700 by itself or networked with one or more other such systems 700 may provide an information handling system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include a graphics processing unit (“CPU”) 707 coupled to CPU 704 and one or more peripheral cards 709 coupled to 110 interface 702. Along those lines, programmed computing device 710 may include graphics memory 708 coupled to optional GPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an SATA bus or other bus. Moreover, one or more SSDs may be used, such as for RAID or other multiple drive storage for example.

I/O interface 702 may include chip set chips, graphics processors, and/or daughter cards, among other known circuits. In this example, 110 interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and 1/0 interface 702. Along those lines, GPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise,

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition program code may be encoded and transmitted via wired optical, and/or wireless networks conforming to a variety of protocols, including the Internet. thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

System 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or other Internet service provider. ISP 726 may in turn provide data communication services through a world-wide packet data communication network, the “Internet” 728. Local network 722 and the Internet 728 may both use electrical, electromagnetic and/or optical signals that carry analog and/or digital data streams. Data carrying signals through various networks, which carry data to and from system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data. GSM Environment (EDGE), wideband code division multiple access (W-CDMA), Long Term Evolution (LTE), LTE-Advanced, WiFi (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WiFi), and/or a long range wireless transceiver (e.g., GSM/CPRS, UMTS, CDMA2000, EV-DO, and LTE/LTE-Advanced) can be used depending on the type of communication or the range of the communication.

System 700 can send messages and receive data, including program code, through network(s) via a network link and communication interface of I/O interface 702. In the Internet example, a server or cloud-based server system 730 might transmit a requested code for an application program through Internet 728, ISP 726, local network 722 and I/O interface 702. Received code may be executed by processor 704 as it is received, and/or stored in a storage device, or other non-volatile storage, of memory 705 for later execution. In this manner, system 700 may obtain application code in the form of a carrier wave.

Cloud-based server system 730 may include one or more backend apps 729. Such one or more backend apps 729 may be for providing services, such as SaaS and/or PaaS solutions, as described elsewhere herein.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

1. A method, comprising:
identifying printers including corresponding network addresses for peer-to-peer print services;
obtaining prices for the peer-to-peer print services associated with the printers;
providing a website- or app-accessible platform (“platform”) for coordinating availability and pricing for the peer-to-peer print services of the printers;
providing a user interface to select a printer of the printers at a price of the prices;
forwarding a print job from the platform to the selected printer of the printers;
printing the print job by the selected printer;
crediting a payment associated with the price to an account associated with the selected printer;
providing a user interface for a buyer for:
loading the print job;
making the payment; and
sending the payment and the print job to the platform with transaction information for the selected printer;
selecting the selected printer at a first location; and
selecting a second location different from the first location to pick up the print job after the printing thereof by the selected printer for the peer-to-peer print services in a share economy model;
wherein the payment is a crypto currency transaction;
wherein the user interface is or has access to a crypto wallet;
wherein the platform comprises a gateway for having network addresses for the printers and network address translation for having the network addresses of the printers as private with a public address for the gateway; and
wherein the platform is operable to forward the print job and corresponding transaction information as the crypto currency transaction to the selected printer for execution of the print job.

2. The method according to claim 1, wherein the forwarding is responsive to the payment for the print job for the selected printer.

3.-5. (canceled)

6. The method according to claim 1, further comprising adjusting the price responsive to user selected features for the print job.

7. The method according to claim 1, further comprising adjusting the price responsive to parameters of the print job.

8. The method according to claim 1, further comprising adjusting the price responsive to demand for the selected printer.

9. (canceled)

10. The method according to claim 1, further comprising generating an interactive display of the printers as selectable objects on a map.

11.-20. (canceled)
